(19) United States
(12) Patent Application Publication
(10) Pub. No.: US 2007/0034530 A1
(43) Pub. Date: Feb. 15, 2007

(54) Method for measuring metal ion concentration

(75) Inventors: Chih-Pen Lin, Tu-cheng (TW); Min Tian, Shenzhen (CN); Da-Wei Gu, Shenzhen (CN); Gang-Sheng Zhang, Shenzhen (CN); Shih-Yi Hong, Tu-cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD, Shindian City (TW)

(21) Appl. No.: 11/453,462

(22) Filed: Jun. 14, 2006

(30) Foreign Application Priority Data
Aug. 12, 2005 (CN) 200510036578.3

(51) Int. Cl. G01N 27/26

(52) U.S. Cl. 205/775

(57) ABSTRACT

A method for measuring metal ion concentration includes the following steps of: providing a measuring solution having metal ion; providing a potential scan device (1); measuring a cyclic voltammetry curve of the measuring solution using the potential scan device 1 at a constant scan rate in a specific potential range, the cyclic voltammetry curve has a peak current; obtaining a linear equation, which indicates a linear relationship of peak current versus a concentration of metal ion in standard metal ion solution in the specific potential range; and determining a concentration of the metal ion of the measuring solution by computing the peak current of the cyclic voltammetry curve of the measuring solution into the linear equation.

### TECHNICAL FIELD

The present invention relates to methods for measuring metal ion concentration and, particularly, to a method for measuring metal ion concentration by means of cyclic voltammetry.

### BACKGROUND

Metal electroplating and etching are typical technologies in surface treatment, and can be used to create decorative films, various functional films, and also in the manufacture of semiconductors. For example, in electroplating nickel technology electroplating bath nickel ion concentration determines thickness, hardness and appearance of a nickel coating. In addition, the etching bath nickel ion concentration determines metal base etching hole size and quality. Therefore, it is necessary to measure and control the nickel ion concentration in an electroplating bath or etching bath.

Generally, nickel ion concentration in electroplating bath or etching bath can be measured, for example, by means of complexometric titration, spectrophotometry, or atomic emission spectroscopy. For complexometric titration, it is necessary to determine titration degree by visually measuring color of a color agent, which has titration error. Also, manufacturing complexant is complicated. For spectrophotometry, some color agents and impurities in electroplating bath or etching bath greatly affect measurement. Using atomic emission spectroscopy to measuring nickel ion concentration is costly.

What is needed, therefore, is a method for measuring metal ion concentration which overcomes above-described shortcomings.

### SUMMARY OF THE INVENTION

In a first preferred embodiment, a measuring method for metal ion concentration includes the steps of: providing a measuring solution having metal ion; providing a potential scanning device; measuring a cyclic voltammetry curve of the measuring solution using the potential scan device at a constant scan rate in a specific potential range; obtaining a linear equation, which indicates a linear relationship of peak current versus concentration of metal ion in standard metal ion solution in the specific potential range; and determining a concentration of the metal ion of the measuring solution by computing the peak current of the cyclic voltammetry curve of the measuring solution into the linear equation.

Other advantages and novel features will become more apparent from the following detailed description when taken in conjunction with the accompanying drawings.

### BRIEF DESCRIPTION OF THE DRAWING

Many aspects of the method for measuring metal ion concentration can be better understood with reference to the following drawing. The components in the drawing are not necessarily drawn to scale, the emphasis instead being placed upon clearly illustrating the principles of the present method for measuring metal ion concentration. Moreover, in the drawing, like reference numerals designate corresponding parts throughout the view.

FIG. 1 is an schematic, isometric view of a potential scan device for achieving a metal ion concentration measuring method, according to a preferred embodiment.

### DETAILED DESCRIPTION OF PREFERRED EMBODIMENTS

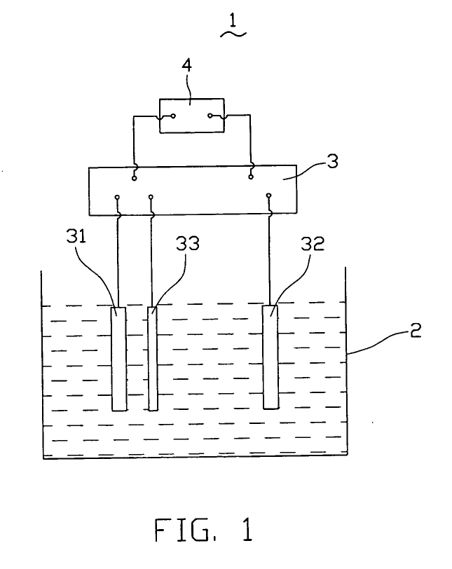

A method for measuring metal ion concentration according to a preferred embodiment is explained by measuring a nickel ion concentration. Referring to FIG. 1, a potential scan device 1 for achieving the measuring method is provided. The method for measuring metal ion concentration includes the following steps of:
(1) providing a measuring solution having metal ion;
(2) providing the potential scan device 1;
(3) obtaining a cyclic voltammetry curve of the measuring solution using the potential scan device 1 to scan the measuring solution at a constant scan rate in a specific potential range, the cyclic voltammetry curve has a peak current (Iₚ);
(4) providing a linear equation, which indicates a linear relationship of a concentration value of reference metal ion solution dependence on a current value, the current value is a peak current of the reference metal ion solution in the specific potential range; and
(5) determining a concentration of metal ion of the measuring solution via linear equation and the peak current of the cyclic voltammetry curve of the measuring solution.

In step one, a solution in an electroplating nickel bath or etching nickel bath is provided. The solution is diluted one hundred times. One hundred milliliters (ml) diluted solution is provided and saved to be used as the measuring solution later.

In step two, the potential scan device 1 includes a container 2, a potentiostat 3, a potential-current recorder 4. The potentiostat 3 includes a working electrode 31, an auxiliary electrode 32, and a reference electrode 33. The working electrode 31 is glass carbon electrode. The auxiliary electrode 32 is platinum electrode. The reference electrode 33 is silver/silver-chloride. The potential-current recorder 4 is electrically connected with the potentiostat 3. The potential-current recorder 4 records current value and potential value of the working electrode 31 simultaneously.

In step three, the measuring solution is placed in the container 2. An ammonia ammonium chloride (NH₃.H₂O—NH₄Cl) solution is titrated into the container 2. At the same time, a PH value of the measuring solution in the container 2 is detected, and maintained at a PH value of 10. The working electrode 31, the auxiliary electrode 32, and the reference electrode 33 are immersed in the container 2. The potential scan device 1 scans measuring solution in the container 2 by means of cyclic voltammetry. The potential range of potentiostat 3 is initiated in the range from −0.4 to −1.3 volts, and a potential scan rate is set to 0.1 volts/s. That is, the potential of working electrode 31 in the measuring solution is linearly cycled from a starting potential of −0.4 volts to a final potential of −1.3 volts and back to the starting potential −0.4 volts via the potential scan device 1 at a scan rate of 0.1 volts/s. The potential is measured between the reference electrode 33 and the working electrode 31 and the current is measured between the working electrode 31 and the auxiliary electrode 32. The potential and the current are recorded by the potential-current recorder 4. The data including the potential and the current is then plotted as potential (E) versus current (I) by the potential-current recorder 4. Thus, a cyclic voltammetry curve of the measuring solution is obtained. In this embodiment a current peak (Iₚ) is produced when the potential of the working electrode 31 is about −1.2 volts.

In step four, a plurality of standard nickel ion solutions, in which ion concentration is known, are provided. The nickel ion concentration of different standard nickel ion solutions is varied. The potential scan device 1 scans each standard nickel ion solutions in the potential range from −0.4 to −0.3 volts and at a scan rate of 0.1 volts/s by means of cyclic voltammetry to obtain a peak current corresponding to the standard nickel ion solutions, as shown in the following table 1, table 2 and table 3. Using the peak currents for the plurality of standard nickel ion solutions, a calibration curve of peak current versus concentration is constructed. It can be found that nickel ion concentration linearly depends on the peak current according to peak current corresponding to the standard nickel ion solutions. Thus, a linear equation is obtained based on the nickel ion concentrations and the corresponding peak currents.

In step five, a nickel ion concentration value of the measuring solution is determined by computing the peak current relating to the measuring solution via the linear equation. The nickel ion concentration value is multiplied by 100. Therefore, a nickel ion concentration in the electroplating nickel bath or etching bath is obtained.

Table 1 to table 3 show experimental records for testing repeatability, accuracy, and effect of interfering ions of the present method. Table 1 shows three groups of peak current values, corresponding to three kinds of standard nickel ion solutions, in which nickel ion (Ni²⁺) concentrations are 10 milligrams/liter (mg/l), 30 mg/l, and 60 mg/l, respectively. Each group of peak current values includes five peak current values, corresponding to five measuring samples of each kind of reference solution.

TABLE 1

| Ni²⁺ | Peak current I_{P} (milliampere (mA)) | | | | |
|---|---|---|---|---|---|
| concentration (mg/l) | 1 | 2 | 3 | 4 | 5 |
| 10 | −2.43 × 10⁻⁵ | −2.46 × 10⁻⁵ | −2.44 × 10⁻⁵ | −2.43 × 10⁻⁵ | −2.46 × 10⁻⁵ |
| 30 | −4.80 × 10⁻⁵ | −4.83 × 10⁻⁵ | −4.79 × 10⁻⁵ | −4.80 × 10⁻⁵ | −4.93 × 10⁻⁵ |
| 60 | −7.53 × 10⁻⁵ | −7.38 × 10⁻⁵ | −7.34 × 10⁻⁵ | −7.68 × 10⁻⁵ | −7.52 × 10⁻⁵ |

Table 2 shows three groups of peak current values, corresponding to three kinds of standard nickel ion solutions, in which nickel ion concentrations are 10 mg/l, 30 mg/l, and 60 mg/l respectively. However, each standard nickel ion solution includes other solutions, in which chloride ion (Cl⁻) concentration is 100 mg/l. Each group of peak current values includes five peak current values, corresponding to five measuring samples of each kind of reference solution.

TABLE 2

| Cl⁻ (100 mg/l) | Peak current I_{P} (mA) | | | | |
|---|---|---|---|---|---|
| Ni²⁺ concentration (mg/l) | 1 | 2 | 3 | 4 | 5 |
| 10 | −2.45 × 10⁻⁵ | −2.47 × 10⁻⁵ | −2.54 × 10⁻⁵ | −2.45 × 10⁻⁵ | −2.51 × 10⁻⁵ |
| 30 | −4.82 × 10⁻⁵ | −4.95 × 10⁻⁵ | −4.97 × 10⁻⁵ | −4.85 × 10⁻⁵ | −4.78 × 10⁻⁵ |
| 60 | −7.43 × 10⁻⁵ | −7.47 × 10⁻⁵ | −7.54 × 10⁻⁵ | −7.38 × 10⁻⁵ | −7.45 × 10⁻⁵ |

Table 3 shows three groups of peak current values, corresponding to three kinds of standard nickel ion solutions, in which nickel ion concentrations are 10 mg/l, 30 mg/l, and 60 mg/l respectively. However, each standard nickel ion solution includes a solution, in which chromic ion (Cr³⁺) concentration is 100 mg/l. Each group of peak current values includes five peak current values, corresponding to five measuring samples of each kind of reference solution.

TABLE 3

| Cr³⁺ (100 mg/l) | Peak current I_{P} (mA) | | | | |
|---|---|---|---|---|---|
| Ni²⁺ concentration (mg/l) | 1 | 2 | 3 | 4 | 5 |
| 10 | −2.54 × 10⁻⁵ | −2.51 × 10⁻⁵ | −2.57 × 10⁻⁵ | −2.44 × 10⁻⁵ | −2.44 × 10⁻⁵ |
| 30 | −4.81 × 10⁻⁵ | −4.86 × 10⁻⁵ | −4.75 × 10⁻⁵ | −4.69 × 10⁻⁵ | −4.80 × 10⁻⁵ |
| 60 | −7.55 × 10⁻⁵ | −7.46 × 10⁻⁵ | −7.36 × 10⁻⁵ | −7.57 × 10⁻⁵ | −7.55 × 10⁻⁵ |

It can be seen from table 1 that a mean deviation of all peak currents is equal to or less than 1.3%. Comparing peak current values shown in table 1 to those in table 3, fractional error of peak current of the standard nickel ion solutions including Cl—, Cr3+ is equal to or less than 2.3%. The method for measuring metal ion concentration is easily operated, and has high accuracy.

The method for measuring metal ion concentration may be used to measure other metal ion concentrations such as copper ion, chromic ion and ferrous ion and so on.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for measuring metal ion concentration comprising the steps of:
providing a measuring solution having a metal ion;
providing a potential scan device;
obtaining a cyclic voltammetry curve of the measuring solution using the potential scan device to scan the measuring solution at a constant scan rate in a specific potential range, wherein the cyclic voltammetry curve has a peak current;
obtaining a linear equation, which indicates a linear relationship of peak current versus a concentration of metal ion in standard metal ion solution in the specific potential range; and
determining a concentration of the metal ion of the measuring solution by computing the peak current of the cyclic voltammetry curve of the measuring solution into the linear equation.

2. The method for measuring metal ion concentration as claimed in claim 1, wherein a determination of the linear equation comprising the steps of: providing a plurality of groups of standard metal ion solutions, in which the metal ion concentration is known; obtaining a cyclic voltammetry curve of each group of standard metal solution using the potential scan device at the constant scan rate in the specific potential range, the cyclic voltammetry curve having a peak current; determining the linear equation base on the metal ion concentration of the reference metal solutions and the corresponding peak current.

3. The method for measuring metal ion concentration as claimed in claim 2, wherein the metal ion is selected from the groups consisting of nickel ion, copper ion, chromic ion, and ferrous ion.

4. The method for measuring metal ion concentration as claimed in claim 2, wherein metal ion is nickel ion.

5. The method for measuring metal ion concentration as claimed in claim 4, further comprising the step of: titrating ammonia ammonium chloride into the measuring solution and the standard metal ion solutions.

6. The method for measuring metal ion concentration as claimed in claim 1, wherein a PH value of the measuring solution and the standard metal ion solutions is 10.

7. The method for measuring metal ion concentration as claimed in claim 1, wherein the constant scan rate is 0.1 volts/s.

8. The method for measuring metal ion concentration as claimed in claim 1, wherein the specific potential range is from −1.3 to −0.4 volts.

9. The method for measuring metal ion concentration as claimed in claim 1, wherein the measuring solution is obtained by the step of diluting a solution including the metal ion in electroplating bath or etching bath one hundred times.

10. The method for measuring metal ion concentration as claimed in claim 1, wherein the potential scan device includes a potentiostat, and a potential-current recorder electrically connected with the potentiostat.

11. The method for measuring metal ion concentration as claimed in claim 10, wherein the potentiostat includes a working electrode, auxiliary electrode, and a reference electrode.

12. The method for measuring metal ion concentration as claimed in claim 11, wherein the working electrode is glass carbon electrode, the auxiliary electrode is Platinum electrode, the reference electrode is silver silver-chloride.
